(19) United States
(12) Patent Application Publication
(10) Pub. No.: US 2011/0072648 A1
(43) Pub. Date: Mar. 31, 2011

(54) METHOD FOR MANUFACTURING SEALED BATTERY

(75) Inventor: Yasuhiro Yamauchi, Sumoto-shi (JP)

(73) Assignee: SANYO ELECTRIC CO., LTD., Osaka (JP)

(21) Appl. No.: 12/879,617

(22) Filed: Sep. 10, 2010

(30) Foreign Application Priority Data
Sep. 30, 2009 (JP) 2009-227185

(51) Int. Cl. H01M 10/04

(52) U.S. Cl. 29/623.2; 29/623.4

(57) ABSTRACT

A sealing plate 12 with an electrolyte pour hole 15 is welded to an outer can 11 having a mouth portion. A resin washer 18 is formed on the electrolyte pour hole 15 so as to cover the periphery of the opening of the electrolyte pour hole and the surface of an annular convex portion 17. Next, a nozzle 23 of an electrolyte pouring device 20 is inserted in the electrolyte pour hole 15, and an electrolyte 21 is poured in. Thereafter, an electrolyte 21b adhering to the surface of the resin washer 18 is cleansed or wiped. Then, a blind rivet 16′ is used as a sealing plug 16 to tightly seal the electrolyte pour hole 15. Thus a method for manufacturing a sealed battery in which a peripheral surface of an electrolyte pour hole hardly gets clouded after manufacturing the battery is provided.

### TECHNICAL FIELD

The present invention relates to a method for manufacturing a sealed battery for sealing an electrolyte pour hole by using a sealing plug with a resin washer interposed therebetween, and more particularly to a method for manufacturing a sealed battery in which a peripheral surface of an electrolyte pour hole rarely becomes clouded after manufacturing the battery.

### BACKGROUND ART

Sealed batteries such as alkaline secondary batteries represented by a nickel-hydrogen secondary battery, and nonaqueous electrolyte secondary batteries represented by a lithium ion secondary battery have been mainly used as a power source of portable electronic devices such as mobile phones, portable personal computers, and portable music players. In recent years, emission regulations for carbon dioxide and similar gases causing global warming have been made more stringent, resulting in the development of electric vehicles (EVs) and hybrid electric vehicles (HEVs) instead of automobiles using only fossil fuels such as gasoline, diesel oil, and natural gas. Sealed batteries such as nickel-hydrogen secondary batteries and lithium ion secondary batteries have also been used as the batteries for these EVs and HEVs.

A related-art sealed battery 10 commonly used includes an outer can 11 in which an electric power generating element such as an electrode assembly is accommodated, a sealing plate 12 sealing the upper mouth portion of the outer can 11, and two electrode terminals 13a and 13d projecting from both sides of the sealing plate 12, as shown in FIG. 4 The sealing plate 12 is further provided with a gas discharge valve 14 for releasing internal pressure when pressure in the outer can 11 becomes high, and an electrolyte pour hole 15 for pouring an electrolyte into the outer can 11. In FIG. 4, the electrolyte pour hole 15 is not directly shown, and only a flange portion of a sealing plug 16 for sealing the electrolyte pour hole 15 is shown. In this manner, the electrolyte pour hole 15 has its opening sealed by the sealing plug 16 so that the electrolyte poured in does not leak out from the outer can 11 (for example, refer to JP-U-59-44027 and JP-A-2003-229118).

FIGS. 5A and 5B show a sealing structure of the electrolyte pour hole by using the sealing plug of the sealed battery 10. FIG. 5A is a cross-sectional view taken along line VA-VA in FIG. 4. An annular convex portion 17 projecting in an axial direction of the can is formed on the peripheral surface of the electrolyte pour hole 15 so as to surround the electrolyte pour hole 15. The sealing plug 16 is made of, for example, aluminum, and includes an axis portion 16a inserted through the electrolyte pour hole 15, a flange portion 16b covering the peripheral surface of the electrolyte pour hole 15, and a crimping portion 16c, and is crimped and fixed to the sealing plate 12 by interposing an annular resin washer 18 between the flange portion 16b and the sealing plate 12. The annular resin washer 18 is interposed between the electrolyte pour hole 15 and the sealing plug 16. The electrolyte pour hole 15 has a high sealing property since the inner circumference portion of the resin washer 18 is partially strongly compressed by the annular convex portion 17 and the flange portion 16b of the sealing plug 16.

As described above, the sealing property of the electrolyte pour hole 15 is increased by forming the annular convex portion 17 on the peripheral surface of the electrolyte pour hole 15 because the inner circumference portion of the resin washer 18 is partially strongly compressed by the annular convex portion 17 and the flange portion 16b of the sealing plug 16. However, the outer circumference portion of the resin washer that is not partially compressed by the annular convex portion 17 may bend downward, whereby only the side end portion of the resin washer may abut to the sealing plate 12, as shown in FIG. 5B. In such a case, a sealed space S is formed between the outer circumference portion of the resin washer and the surface of the sealing plate 12.

Usually, in the electrolyte pouring step, the electrolyte adheres and remains on the peripheral surface of the electrolyte pour hole 15. Therefore, cleansing is performed after sealing the electrolyte pour hole 15 in order to remove the adhered electrolyte. However, if the electrolyte remains in the sealed space S, the electrolyte may not be removed even by cleansing because of being blocked by the resin washer 18. The electrolyte remaining in the sealed space S after the cleansing gradually leaches to the outside of the resin washer 18 after the battery testing step following cleansing step or after shipping. Therefore, there was a problem that the periphery of the resin washer 18 becomes clouded due to a reaction of a solute component of the electrolyte and water content in the air. In the case where the periphery of the resin washer 18 is clouded, there is a problem of not being able to determine whether the cloud is due to a non-progressive electrolyte remaining in the sealed space S, or due to electrolyte leakage caused by poor sealing of the electrolyte pour hole 15.

In addition, the manufacturing step of the sealed battery includes an airtightness testing step after sealing and welding of the outer can 11 and the sealing plate 12. In this airtightness testing step, a testing nozzle is inserted through the electrolyte pour hole 15, and the testing gas is pressurized and injected. Due to the interference of the electrolyte pour hole 15 and the testing nozzle at the time of inserting the testing nozzle, the electrolyte pour hole 15 may be damaged. As a result, a problem emerges in that the sealing property of the sealing portion of the electrolyte pour hole is impaired. The same holds for the interference between the electrolyte pour hole 15 and the pouring nozzle in the electrolyte pour step, and the interference between the electrolyte pour hole 15 and the sealing plug 16 in the sealing step.

### SUMMARY

The inventors have reexamined the related-art manufacturing step of the sealed battery, and have found out that the problems will be solved if the resin washer is arranged around the opening of the electrolyte pour hole at the time of inserting the airtightness testing nozzle, at the electrolyte pouring step, and at the time of inserting the sealing plug in the sealing step, and therefore, achieved to complete the present invention. Specifically, an advantage of some aspects of the invention is to provide a method for manufacturing a sealed battery that can prevent the electrolyte from remaining around the electrolyte pour hole, and can also prevent impairment of the sealing property of the sealing portion of the electrolyte pour hole by preventing the deformation of the electrolyte pour hole when manufacturing the sealed battery by having the resin washer arranged around the opening of the electrolyte pour hole at the time of inserting the airtightness testing nozzle, at the time of inserting the electrolyte pouring nozzle, and at the time of inserting the sealing plug.

A method for manufacturing a sealed battery according to an aspect of the invention includes: welding and fixing, by using an outer can having a mouth portion and a sealing plate having an electrolyte pour hole, the sealing plate to the mouth portion of the outer can; adhering and fixing a resin washer around an opening hole of the electrolyte pour hole before or after the welding and fixing of the sealing plate to the mouth portion of the outer can; pouring electrolyte in the outer can through the electrolyte pour hole after the welding and fixing and the adhering and fixing; and sealing the electrolyte pour hole with a sealing member.

In the method for manufacturing a sealed battery according the aspect of the invention, the resin washer is adhered and fixed around the opening hole of the electrolyte pour hole of the sealing plate when the electrolyte is poured into the outer can through the electrolyte pour hole. Generally, in the electrolyte pouring step, cleansing is performed to remove the adhered electrolyte since the electrolyte adheres and remains in the peripheral surface of the electrolyte pour hole. In the method for manufacturing a sealed battery according to the aspect of the invention, the electrolyte rarely enters between the resin washer and the sealing plate even if the electrolyte is adhering to the surface of the resin washer after the electrolyte is poured in since there is no gap between the resin washer and the sealing plate. Thus, with the method for manufacturing a sealed battery according to the aspect of the invention, the adhered electrolyte can be easily and thoroughly cleansed even if the electrolyte is adhering to the surface of the resin washer.

Also, contact between a nozzle for pouring the electrolyte and the electrolyte pour hole, contact between a testing nozzle for supplying a pressurized gas and the electrolyte pour hole in the airtightness testing step, and contact between a sealing member and the electrolyte pour hole when inserting the sealing member into the electrolyte pour hole can be prevented, and therefore the electrolyte pour hole can be prevented from being damaged, and the sealing property of the electrolyte pour hole can be preferably maintained. In addition, in the method for manufacturing a sealed battery of the aspect of the invention, judgment can be clearly made that the electrolyte leakage is due to poor sealing if the periphery of the resin washer is clouded in the battery testing step after cleansing or after shipping.

Polytetrafluoroethylene (PTFE), tetrafluoroethylene-perfluoroalkoxy ethylene copolymer (PFA), polypropylene (PP), polyphenylene sulfide (PPS), tetrafluoroethylene-ethylene copolymer (ETFE), and ethylene-propylene rubber (EPDM) and the like can be cited as the resin washer that can be used in the method for manufacturing a sealed battery according to the aspect of the invention regarding the resistance and the repelling property with respect to a nonaqueous electrolyte.

In the method for manufacturing a sealed battery according to the aspect of the invention, the sealing plate is preferably used having a structure in which an annular convex portion is formed in the periphery of the opening of the electrolyte pour hole, and the resin washer also covers the surface of the annular convex portion.

Mechanical strength is applied to the periphery of the electrolyte pour hole by forming the annular convex portion in the periphery of the opening of the electrolyte pour hole. Therefore, the peripheral portion of the electrolyte pour hole can be prevented from being deformed even if a stress is applied to the peripheral portion of the electrolyte pour hole during sealing. Thus, in the sealed battery of the invention, a high sealing property can be maintained by applying high stress to the sealing member of the electrolyte pour hole.

In the method for manufacturing a sealed battery according to the aspect of the invention, a sealing plate having a structure in which the resin washer is integrally formed by the outsert molding method may be used as the sealing plate.

The sealing plate and the resin washer can be integrally formed by the outsert molding method. Therefore, in the method for manufacturing a sealed battery of the aspect of the invention, the electrolyte more rarely enters the gap between the resin washer and the sealing plate, and therefore, the above effects can further preferably be achieved.

In the method for manufacturing a sealed battery of the invention, a sealing plate having a structure in which the resin washer is thermally deposited or adhered by an adhesive may be used as the sealing plate.

Gaps can also be prevented from being generated between the sealing plate and the resin washer by thermally depositing or adhering by an adhesive the resin washer to the sealing plate. Thus, the above effects can further preferably be achieved by the invention.

In the method for manufacturing a sealed battery according to the aspect of the invention, a blind rivet is preferably used as the sealing member.

The blind rivet is made of metal, and can tightly seal the electrolyte pour hole. Also, once after the electrolyte pour hole is sealed, the sealed state can preferably be maintained. Thus, in the method for manufacturing a sealed battery according to the aspect of the invention, a sealed battery having a reliable sealing portion can be obtained.

### BRIEF DESCRIPTION OF THE DRAWINGS

FIGS. 1A to 1F are diagrams showing a sealing step of an electrolyte pour hole of a sealed battery of an embodiment of the present invention.

FIG. 2A is a cross-sectional view of a blind rivet for forming a sealing plug, and FIG. 2B is an enlarged view of a part IIB of FIG. 1.

FIGS. 3A to 3E are diagrams showing a sealing step of an electrolyte pour hole of a related-art sealed battery.

FIG. 4 is a perspective view of a related-art sealed battery.

FIG. 5A is a cross-sectional view taken along a line VA-VA of FIG. 4, and FIG. 5B is an enlarged view of a part VB of FIG. 5A.

### DESCRIPTION OF EXEMPLARY EMBODIMENTS

### Embodiment

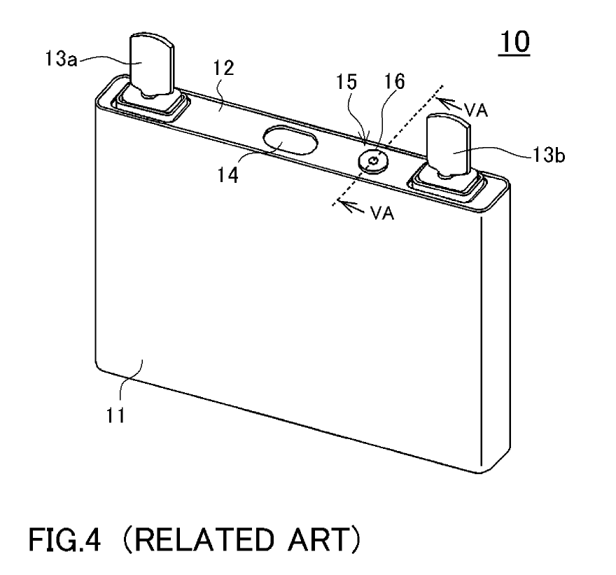

Hereinafter, an embodiment of the invention will be described in detail with reference to the accompanied drawings. The sealed battery of the embodiment has the same appearance as the related-art sealed battery shown in FIG. 4. Therefore, the same reference numerals are denoted for the same components as those of the related-art sealed battery, and the explanation will be given with reference to FIG. 4 as necessary. The sealed battery 10 of the embodiment includes the outer can 11, and the sealing plate 12 sealing the upper mouth portion of the outer can 11, as shown in FIG. 4. The sealing plate 12 includes the two electrode terminals 13a and 13b, the gas discharge valve 14, and the electrolyte pour hole 15.

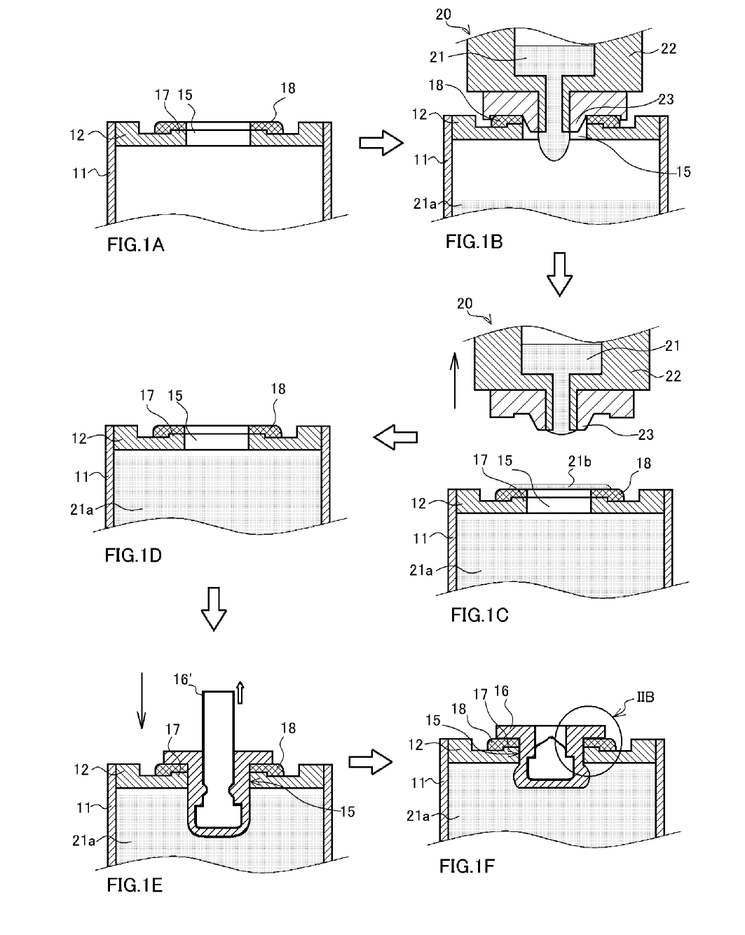

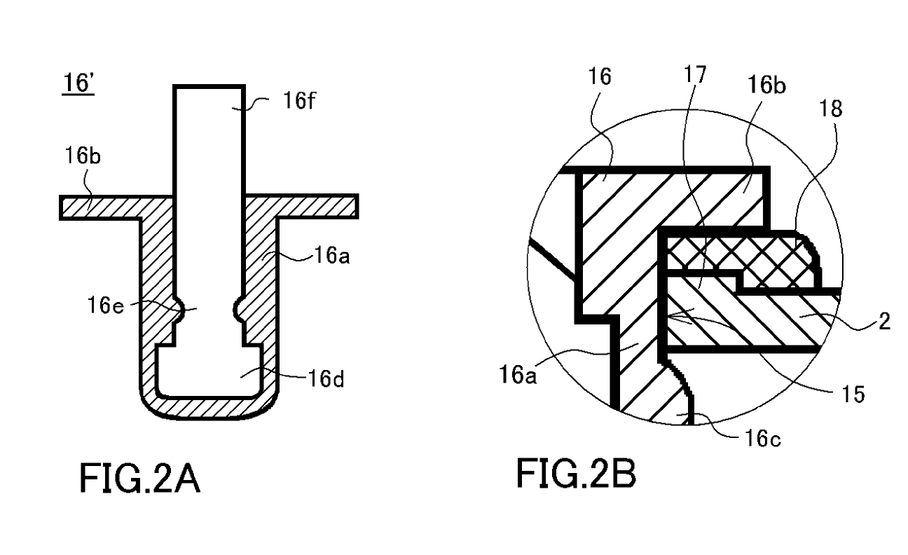

As shown in FIG. 1F and FIG. 2B, the sealing plug (corresponds to a “sealing member” of the invention) 16 formed of a blind rivet and the resin washer 18 are attached to the electrolyte pour hole 15. Also, the annular convex portion 17 projecting in an axial direction of the can is formed on the peripheral surface of the electrolyte pour hole 15 of the sealing plate 12 so as to surround the electrolyte pour hole 15. Although the annular convex portion 17 is not always necessary, the peripheral strength of the electrolyte pour hole 15 increases, and also the sealing property of the electrolyte pour hole 15 is increased by providing this annular convex portion.

The sealing plug 16 includes the axis portion 16a inserted through the electrolyte pour hole 15, the flange portion 16b covering the peripheral surface of the electrolyte pour hole 15, and the crimping portion 16c, and is crimped and fixed to the sealing plate 12 by the flange portion 16b and the crimping portion 16c. The annular resin washer 18 is interposed between the peripheral surface of the electrolyte pour hole 15 and the flange portion 16b of the sealing plug 16. The resin washer 18 is partially strongly compressed by the annular convex portion 17 formed so as to surround the electrolyte pour hole 15, and thereby maintaining the high sealing property of the electrolyte pour hole 15.

Next, a sealing step of the electrolyte pour hole 15 of the sealed battery of the embodiment will be explained with reference to FIG. 1. At first as shown in FIG. 1A, the sealing plate 12 is prepared in which the resin washer 18 is formed so as to cover the periphery of the opening of the electrolyte pour hole 15 and the surface of the annular convex portion 17. The resin washer 18 needs to be formed so as not to generate gaps between the resin washer 18 and the surface of the sealing plate 12. Therefore, the resin washer 18 is preferably formed integrally with the sealing plate 12 by the outsert molding method. PFA, PP, PPS, PTFE, ETFE, EPDM, and the like may be used as a latching member of the resin washer 18 regarding the resistance and the repelling property with respect to a nonaqueous electrolyte. Among these, the resin washer 18 made of PFA, PP, PPS, ETFE, and the like that is thermoplastic resin can easily be formed integrally with the sealing plate 12 by thermal deposition. Also, by adhering by a rubber-based adhesive, the resin washer 18 and the sealing plate 12 can be formed integrally.

Next, the two electrode terminals 13a and 13b, and the gas discharge valve 14 can be formed in the sealing plate 12, as shown in FIG. 4. Further, although not shown in the drawings, an electrode assembly including a positive electrode, a negative electrode, and a separator is prepared. A positive collector and a negative collector are respectively connected to the electrode terminals 13a and 13b. Next, the electrode assembly is inserted into the outer can 11, the sealing plate 12 is fitted in the mouth portion of the outer can 11, and the joint section of the outer can 11 and the sealing plate 12 is welded by laser welding, for example. FIG. 1A illustrates the above state. Note that, in FIG. 1A, the structure of the electrode assembly is omitted (hereinafter, the same is said for FIG. 1B to FIG. 1F).

Next, an electrolyte pouring device 20 is prepared. The electrolyte pouring device 20 has on its upper portion an electrolyte tank 22 filled with an electrolyte 21, and on its lower portion is a tapered nozzle 23 for pouring the electrolyte 21 into the sealed battery 10. The inside of the electrolyte tank 22 can be pressurized in order to enhance the pouring speed of the electrolyte 21.

First, as shown in FIG. 1B, the nozzle 23 of the electrolyte pouring device 20 is inserted in the electrolyte pour hole 15 formed on the sealing plate 12. The inside of the electrolyte tank 22 is pressurized as necessary, and a predetermined amount of electrolyte 21 is poured. After pouring a predetermined amount of electrolyte 21a, the electrolyte pouring device 20 is lifted up so as to withdraw the nozzle 23 of the electrolyte pouring device 20 from the electrolyte pour hole 15 of the sealing plate 12. At this time, as shown in FIG. 1C, although the predetermined amount of electrolyte 21a is poured in the outer can 11, an electrolyte 21b is adhering to the surface of the resin washer 18 by atomizing or dripping the electrolyte during electrolyte pouring. The electrolyte 21b adhering to the surface of the resin washer 18 is removed by cleansing or wiping. FIG. 1D shows the state after the removing.

Next, as shown in FIG. 1E, a blind rivet 16′ for forming the sealing plug 16 is inserted in the electrolyte pour hole 15. As shown in FIG. 2, this blind rivet 16′ includes the cylindrical axis portion 16a to be inserted in the electrolyte pour hole 15 and the flange portion 16b formed on the upper end portion of the axis portion 16a with each formed of aluminum metal, for example. The tip end portion of the axis portion 16a is shaped like a bag. A stainless-steel core axis portion 16f with a large-diameter portion 16d formed on its tip end and a small-diameter portion 16e formed over the large-diameter portion 16d is provided inside of the axis portion 16a. The axis portion 16a of the sealing plug 16 is inserted in the electrolyte pour hole 15 from the annular resin washer 18 side so that the flange portion 16b and the annular resin washer 18 are contacting each other.

Next, the core axis portion 16f is lifted up while pressing the flange portion 16b of the blind rivet 16′ towards the sealing plate 12 side, and the large-diameter portion 16d at the tip end of the core axis portion 16f moves upward. Then, the diameter of the bag-like portion at the tip end of the axis portion 16a of the blind rivet 16′ increases, and the crimping portion 16c is formed. Thus, the blind rivet 16′ is fixed in the electrolyte pour hole 15, and the core axis portion 16f of the blind rivet 16′ is cut off at the small-diameter portion 16e formed over the large-diameter portion 16d. As a result, as shown in FIG. 1F, the electrolyte pour hole 15 can be tightly sealed by the sealing plug 16.

### Comparative Example

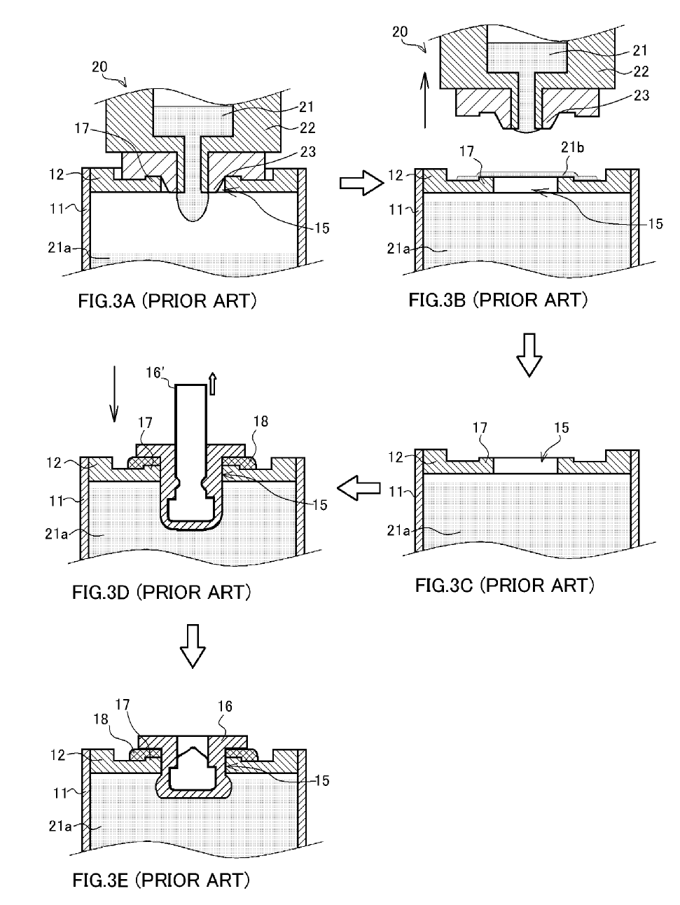

Next, with reference to FIG. 3 to FIG. 5, a sealing step of an electrolyte pour hole in the related-art sealed battery will be explained as a comparative example in order to confirm the effect of the method for manufacturing a sealed battery of the above embodiment. Also, in FIG. 3, the same reference numerals are denoted for the same components as those in the sealing step of the electrolyte pour hole in the above embodiment, and the detailed descriptions thereof will be omitted.

First, a battery having a structure in which the annular convex portion 17 projecting in an axial direction of the can is formed on the peripheral surface of the electrolyte pour hole 15 of the sealing plate 15 so as to surround the electrolyte pour hole 15. Next, as shown in FIG. 4, the two electrode terminals 13a and 13b, and the gas discharge valve 14 are formed in the sealing plate 12. Further, although omitted in the drawings, an electrode assembly including a positive electrode, a negative electrode, and a separator is prepared, and a positive collector and a negative collector are respectively connected to the electrode terminals 13a and 13b. Next, the electrode assembly is inserted in the outer can 11, the sealing plate 12 is fitted in the mouth portion of the outer can 11, and the joint section of the outer can 11 and the sealing plate 12 are welded by laser welding, for example. Thereafter, the nozzle 23 of the electrolyte pouring device 20 is inserted in the electrolyte pour hole 15 formed in the sealing plate 12, the inside of the electrolyte tank 22 is pressurized as necessary, and a predetermined amount of the electrolyte 21 is poured. FIG. 3A illustrates the above state. However, in FIG. 3A, the structure of the electrode assembly is omitted (hereinafter, the same is said for FIG. 3B to FIG. 3E).

After pouring a predetermined amount of electrolyte 21a, the electrolyte pouring device 20 is lifted up and the nozzle 23 of the electrolyte pouring device 20 is withdrawn from the electrolyte pour hole 15 of the sealing plate 12. At this time, as shown in FIG. 3B, although the predetermined amount of electrolyte 21a is poured in the outer can 11, an electrolyte 21b adheres to the peripheral surface of the electrolyte pour hole 15 of the sealing plate 12 by atomizing or dripping the electrolyte during electrolyte pouring. The electrolyte 21b adhering to the peripheral surface of the electrolyte pour hole 15 of the sealing plate 12 is removed by cleansing or wiping. FIG. 3C shows the state after removal.

Next, as shown in FIG. 3D, the resin washer 18 is inserted into the tip end of the blind rivet 16′, and the tip end of the blind rivet 16′ is inserted in the electrolyte pour hole 15. Thereafter, the core axis portion 16f is lifted up while pressing the flange portion 16b of the blind rivet 16′ towards the sealing plate 12 side, and whereby the electrolyte pour hole 15 can be sealed in a liquid tight manner by the sealing plug 16 as shown in FIG. 3E.

Leaching Text

A leaching test was performed as described below by using the sealed battery of the embodiment manufactured by performing the sealing step of the electrolyte pour hole of the embodiment as described above, and the sealed battery of the comparative example manufactured by performing the sealing step of the related-art electrolyte pour hole. Note that a lithium ion secondary battery was used as the sealed battery.

First, the overall battery was cleansed and visually checked. Thereafter, a battery with no faults was charged until the charge depth reached SOC=60% (where the charging voltage 4.1V is SOC=100%) by a predetermined charging method. This battery was placed in a constant-temperature bath maintained at a relative humidity RH=90% and 60° C. for 24 hours. Thereafter, the periphery of the sealing plug 16 was checked for the presence of leaching by observing with a 50-power microscope. In this case, the case where a white-colored smudge was confirmed at the periphery of the sealing plug 16 was judged as a presence of leaching. The batteries used in the comparative examples 1 and 2, and the embodiment were manufactured as follows.

### Comparative Example 1

A battery with no resin washer formed was manufactured by performing the following steps (1) to (7) and used as the battery of the comparative example 1.

(1) a step of pouring electrolyte
(2) a step of pressing and wiping with a nonwoven fabric
(3) a step of aging the battery after leaving it for a predetermined period of time
(4) a step of degassing the outer can by reducing the pressure inside the outer can
(5) a step of pressing and wiping with a nonwoven fabric
(6) a step of sealing the battery by using a blind rivet
(7) a step of cleansing the battery by using purified water

### Comparative Example 2

A battery with no resin washer formed was manufactured by performing the following steps (1) to (8) and used as the battery of comparative example 2.

(1) a step of pouring electrolyte
(2) a step of pressing and wiping with a nonwoven fabric
(3) a step of aging the battery after leaving it for a predetermined period of time
(4) a step of degassing the outer can by reducing the pressure inside the outer can
(5) a step of dropping dimethyl carbonate (DMC) in the periphery of the pour hole
(6) a step of pressing and wiping with a nonwoven fabric
(7) a step of sealing the battery by using a blind rivet
(8) a step of cleansing the battery by using purified water

### Embodiment

A battery with a resin washer formed was manufactured by performing the same steps as those in the comparative example 1 and used as the battery for the embodiment.

The results of the leaching tests of the batteries of the comparative examples 1 and 2, and the embodiment are summarized below in Table 1.

TABLE 1

| | DMC | | |
|---|---|---|---|
| | Cleansing | Leaching test result | (%) |
| Comparative | No | 225 cells among 353 cells | 63.7% |
| Example 1 | | | |
| Comparative | Yes | 21 cells among 207 cells | 10.1% |
| Example 2 | | | |
| Embodiment | No | 2 cells among 247 cells | 0.8% |

DMC: dimethyl carbonate

The leaching rate difference between the comparative examples 1 and 2, and the embodiment can be understood as follows. Specifically, in the methods for manufacturing the sealed batteries of the comparative examples 1 and 2, the electrolyte 21b adhering to the peripheral surface of the electrolyte pour hole 15 of the sealing plate 12 when the electrolyte is poured in from the electrolyte pour hole 15 is removed only by wiping in the comparative example 1, and by cleansing and wiping in the comparative example 2, as shown in FIG. 3C. However, thoroughly removing the electrolyte adhering to the surface of the sealing plate 12 even by cleansing is difficult in a micro view since the sealing plate made of metal and the electrolyte have good wettability, for example.

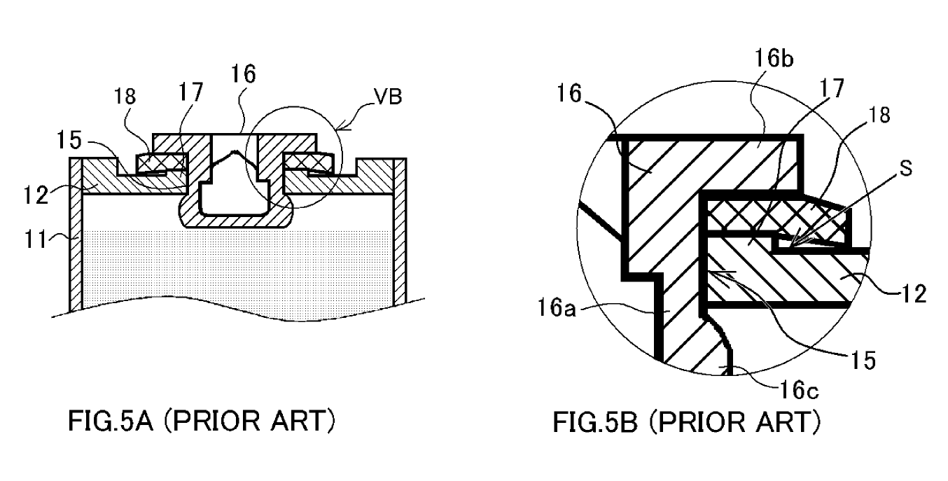

Also, in the methods for manufacturing the sealed batteries of the comparative examples 1 and 2, the resin washer 18 is inserted in the tip end of the blind rivet 16′, and the tip end of the blind rivet 16′ is inserted in the electrolyte pour hole 15 after removing the electrolyte 21b adhering to the peripheral surface of the electrolyte pour hole 15 of the sealing plate 12, as shown in FIG. 3D, whereby the resin washer 18 is fixed so as to cover the electrolyte pour hole 15 and the annular convex portion 17. Thus, with the methods for manufacturing the sealed batteries of the comparative examples 1 and 2, a sealed space S may be formed between the resin washer 18 and the sealing plate 12, and therefore, the electrolyte adhering to the surface of the sealing plate 12 may remain in the sealed space S, as shown in FIG. 5B. This is considered the reason of confirmation of the white-colored smudge in the periphery of the sealing plug 16 as described above due to the electrolyte remained in the sealed space S.

On the other hand, with the method for manufacturing the sealed battery of the embodiment, the electrolyte rarely enters the sealed space S even if the sealed space S as shown in FIG. 5B is formed between the resin washer 18 and the sealing plate 12, since the resin washer 18 is formed in advance in the periphery of the electrolyte pour hole 15 of the sealing plate 12 which is clean before pouring the electrolyte. Also, it is considered that the above described white-colored smudge is rarely generated around the sealing plug 16 since the electrolyte adhering to the surface of the resin washer 18 can be easily removed.

In addition, with the method for manufacturing a sealed battery according to the embodiment, contact between the nozzle 23 of the electrolyte pouring device 20 and the electrolyte pour hole 15, contact between the testing nozzle for supplying a pressurized gas in the airtightness testing step and the electrolyte pour hole 15, and contact between the blind rivet 16′ and the electrolyte pour hole 15 in the step shown in FIG. 1E can be prevented, and therefore, the electrolyte pour hole 15 can be prevented from being damaged, and the sealing property of the electrolyte pour hole 15 can be preferably maintained. In addition, with the method for manufacturing the sealed battery of the invention, judgment can be clearly made that the electrolyte leakage is due to poor sealing in a case where the periphery of the resin washer is clouded in a battery testing step after cleansing or after shipping.

Moreover, as the embodiment, the example shown is the one in which the resin washer is adhered and fixed around the opening hole of the electrolyte pour hole before welding and fixing the sealing plate to the outer can. However, the resin washer may be formed before pouring the electrolyte. Therefore, the resin washer can be adhered and fixed around the opening hole of the electrolyte pour hole after welding and fixing the sealing plate to the outer can. Also, although the blind rivet is used as the sealing plug in the above embodiment, a resin or ceramic sealing plug can also be used in addition to the blind rivet. In this case, the resin or ceramic sealing plug is preferably fixed in the electrolyte pour hole by an adhesive.

What is claimed is:

1. A method for manufacturing a sealed battery, the method comprising:
welding and fixing a sealing plate having an electrolyte pour hole to a mouth portion of an outer can having the mouth portion;
adhering and fixing a resin washer around the electrolyte pour hole before or after the welding and fixing of the sealing plate to the mouth portion of the outer can;
pouring an electrolyte into the outer can through the electrolyte pour hole after the welding and fixing and the adhering and fixing; and
sealing the electrolyte pour hole with a sealing member.

2. The method for manufacturing a sealed battery according to claim 1, wherein the sealing plate having a structure in which an annular convex portion is formed in the periphery of the opening of the electrolyte pour hole, and the resin washer also covers the surface of the annular convex portion is used.

3. The method for manufacturing a sealed battery according to claim 1, wherein the sealing plate having a structure in which the resin washer is integrally formed by the outsert molding method is used.

4. The method for manufacturing a sealed battery according to claim 2, wherein the sealing plate having a structure in which the resin washer is integrally formed by the outsert molding method is used.

5. The method for manufacturing a sealed battery according to claim 1, wherein the sealing plate having a structure in which the resin washer is thermally deposited or adhered by an adhesive is used.

6. The method for manufacturing a sealed battery according to claim 2, wherein the sealing plate having a structure in which the resin washer is thermally deposited or adhered by an adhesive is used.

7. The method for manufacturing a sealed battery according to claim 1, wherein a blind rivet is used as the sealing member.
